(19) United States
(12) Patent Application Publication
(10) Pub. No.: US 2007/0110227 A1
(43) Pub. Date: May 17, 2007

(54) Method and apparatus for reproducing contents data

(75) Inventor: Kentaro Yokouchi, Kanagawa-ken (JP)

Correspondence Address: LOUIS WOO;LAW OFFICE OF LOUIS WOO, 717 NORTH FAYETTE STREET, ALEXANDRIA, VA, 22314, US

(73) Assignee: Victor Company of Japan, Ltd., Yokohama (JP)

(21) Appl. No.: 11/486,078

(22) Filed: Jul. 14, 2006

(30) Foreign Application Priority Data
Jul. 27, 2005 (JP) 2005-218035
May 25, 2006 (JP) 2006-144976

(51) Int. Cl. H04L 9/28

(52) U.S. Cl. 380/28

(57) ABSTRACT

Encrypted contents data and a non-core decryption software program are read out from a recording medium. The non-core decryption software program corresponds to a non-core portion of a decryption algorithm. The read-out encrypted contents data is processed into first processed contents data by executing the read-out non-core decryption software program. A hardware decryptor is enabled to process the first processed contents data into second processed contents data by implementing a core portion of the decryption algorithm.

### BACKGROUND OF THE INVENTION

1. Field of the Invention

This invention generally relates to a method and an apparatus for reproducing contents data. This invention particularly relates to a method and an apparatus for reading out encrypted contents data from a recording medium and decrypting the read-out contents data to reproduce original contents data.

2. Description of the Related Art

Digital versatile discs (DVDs) include DVD-ROM discs. There is DVD-Video that is a standard for storing and reproducing audio and video on DVD-ROM discs based on MPEG (Moving Picture Experts Group) video, Dolby Digital and MPEG audio, and other proprietary data formats.

In general, contents data stored in a DVD-Video disc is generated as follows. Original contents data is compressed and encoded according to the MPEG standards. Then, the resultant compressed MPEG data is encrypted by the industry's Content Scrambling System (CSS) to get encrypted contents data to be stored in a disc. The CSS encryption is intended to protect a copyright on the contents data.

According to the CSS, compressed MPEG data is encrypted in response to a title key, a disc key, and a master key. Only a DVD player licensed to perform CSS decryption is allowed to get decryption keys, and decrypt CSS encrypted data through the use of the decryption keys to reproduce original contents data. The CSS requires a DVD-ROM drive and an MPEG decoder module in a personal computer system to implement mutual authentication to prohibit illegal data transfer therebetween.

There are data scrambling systems different from the CSS. The CSS utilizes only a single predetermined algorithm for each of encryption and decryption. Thus, a typical DVD player licensed to perform CSS decryption can not handle a DVD storing encrypted contents data which results from scrambling original contents data in a way different from the CSS. In addition, the typical DVD player is unable to adaptively follow the updating of an algorithm for scrambling original contents data.

Japanese patent application publication number 2000-124894 corresponding to U.S. Pat. No. 6,236,727 discloses a computer system including a CPU within which a primary software module and a secondary software module are executed. The primary software module contains a data processing module and an encryption module. The secondary software module contains a decryption module and a data processing module. The computer system further includes a processing hardware device connected to the CPU via a system memory and a system bus. The processing hardware device has a decryption device and a data processing device.

In the computer system of Japanese application 2000-124894, the data processing module within the primary software module descrambles CSS encrypted data to recover original data. Copyright data in the recovered original data is then re-encrypted by the encryption module using an encryption algorithm other than the CSS encryption. The encrypted copyright data can be transferred to the secondary software module or the processing hardware device. The decryption module within the secondary software module or the decryption device within the processing hardware device decrypts the encrypted copyright data. The resultant decrypted data is then processed by the data processing module within the secondary software module or the data processing device within the processing hardware device.

Thus, in the computer system of Japanese application 2000-124894, the encryption of the copyright data is implemented by the software module. Generally, it is easy to illegally access and analyze such a software module. If the software module is fully analyzed, copyright protection will be invalidated or broken. Accordingly, the computer system of Japanese application 2000-124894 tends to be poor in anti-tamper performances.

### SUMMARY OF THE INVENTION

It is a first object of this invention to provide an apparatus for reproducing contents data which can be efficiently adapted to a plurality of encryption systems, which can easily follow a new encryption system, and which is high in anti-tamper performances.

It is a second object of this invention to provide a method of reproducing contents data which can be efficiently adapted to a plurality of encryption systems, which can easily follow a new encryption system, and which is high in anti-tamper performances.

A first aspect of this invention provides a contents-data reproducing apparatus comprising a signal reader for reading out encrypted contents data and a non-core decryption software program from a recording medium, the non-core decryption software program corresponding to a non-core portion of a decryption algorithm; a non-core decryptor for processing the read-out encrypted contents data into first processed contents data by executing the read-out non-core decryption software program; and a core decryptor including a hardware device for processing the first processed contents data into second processed contents data by implementing a core portion of the decryption algorithm.

A second aspect of this invention is based on the first aspect thereof, and provides a contents-data reproducing apparatus wherein the core decryptor comprises an external bus; an internal bus physically separate from the external bus; a command register for receiving a command from the non-core decryptor via the external bus; a data register for receiving input data from the non-core decryptor via the external bus, and for sending output data to the non-core decryptor via the external bus; a decryption hardware module for processing the input data while implementing the core portion of the decryption algorithm; a sequencer for controlling the data register and the decryption hardware module in response to the command received by the command register so that the input data will be sent from the data register to the decryption hardware module via the internal bus and will be processed into the output data by the decryption hardware module, and that the output data will be sent from the decryption hardware module to the data register via the internal bus.

A third aspect of this invention is based on the first aspect thereof, and provides a contents-data reproducing apparatus wherein the decryption algorithm is for contents protection, and the core portion of the decryption algorithm which is implemented by the core decryptor includes a process repetitively using a cipher function.

A fourth aspect of this invention is based on the first aspect thereof, and provides a contents-data reproducing apparatus wherein the core portion of the decryption algorithm which is implemented by the core decryptor includes a process using a cipher function.

A fifth aspect of this invention provides a contents-data reproducing method comprising the steps of reading out encrypted contents data and a non-core decryption software program from a recording medium, the non-core decryption software program corresponding to a non-core portion of a decryption algorithm; processing the read-out encrypted contents data into first processed contents data by executing the read-out non-core decryption software program; and enabling a hardware decryptor to process the first processed contents data into second processed contents data by implementing a core portion of the decryption algorithm.

This invention has advantages as mentioned below. Although the core portion of the decryption algorithm remains the same, the decryption algorithm changes as the non-core portion thereof or the non-core decryption software program changes. Therefore, the decryption algorithm can easily be replaced with new one or updated into a new version by changing the non-core decryption software program. A change in the non-core decryption software program enables the contents-data reproducing apparatus to efficiently follow one selected from different encryption/decryption systems utilizing different encryption/decryption algorithms respectively. Furthermore, a change in the non-core decryption software program enables the contents-data reproducing apparatus to follow a new encryption/decryption system without modification of the core decryptor.

The core decryptor implements the core portion of the decryption algorithm. The core decryptor is formed by the hardware device which is difficult to analyze. Thus, it is possible to provide anti-tamper performances higher than those occurring in an assumed case where the whole of the decryption algorithm is implemented by executing a corresponding decryption software program.

### BRIEF DESCRIPTION OF THE DRAWINGS

FIG. 1 is a plan view of a recording medium in a first embodiment of this invention.

FIG. 2 is a diagram of the structure of a recording area in the recording medium of FIG. 1.

FIG. 3 is a block diagram of a contents-data recording apparatus in the first embodiment of this invention.

FIG. 4 is a block diagram of a contents-data reproducing apparatus in the first embodiment of this invention.

FIG. 5 is a block diagram of a hybrid decryptor in FIG. 4.

FIG. 6 is a block diagram of a core decryptor in FIG. 5.

FIG. 7 is a diagram showing an example of the format of a command written into a command register in FIG. 6.

FIG. 8 is a diagram showing an example of the format of data stored in a data register in FIG. 6.

FIG. 9 is a diagram showing an example of the format of a status set in a status register in FIG. 6.

FIG. 10 is a diagram showing an example of state transitions of a sequencer in FIG. 6.

FIG. 11 is a diagram of a disc making equipment, a DVD-Audio disc, and a contents-data reproducing apparatus in a third embodiment of this invention.

FIG. 12 is a flowchart of a decryption procedure which is performed by the reproducing apparatus in FIG. 11 for copyright protection based on the CPPM system.

FIG. 13 is a data flow chart of a DES encrypting computation procedure executed by a contents-data recording apparatus in a fourth embodiment of this invention.

### DETAILED DESCRIPTION OF THE INVENTION

### First Embodiment

According to a first embodiment of this invention, a recording medium relates to an application format. An example of the recording medium is a DVD (digital versatile disc). The DVD relates to a DVD application format. The recording medium stores encrypted contents data which is generated from original contents data in a below-indicated procedure. Usually, the original contents data is copyrighted.

The original contents data is subjected to an authoring process and a premastering process. As a result, the original contents data is converted into processed contents data. The authoring process includes a step of generating a data structure in accordance with the application format to which the recording medium relates. In the case where the recording medium is a DVD, the authoring process includes a step of performing data compression according to, for example, the DVD-Video standards. The premastering process includes a step of generating a data structure accorded with a logical format such as a file system.

The processed contents data is converted into encrypted contents data through a prescribed encryption process for copyright protection which is required in connection with the application format and the logical format. A recording medium storing the encrypted contents data is made in a known way. The encrypted contents data may be recorded on the recording medium via a recording-medium drive. A first example of the prescribed encryption process utilizes the industry's Content Scrambling System (CSS). When the CSS is utilized, the prescribed encryption process includes at least one among a step of encrypting data, a step of processing data according to a one-way function, and a step of adding flag data. A second example of the prescribed encryption process utilizes a data scrambling system (a data encryption system) other than the CSS. In this case, the prescribed encryption process includes a step of generating data with an added electronic signature (digital signature).

For authorized use of copyrighted contents data, it is required to implement at least one of data decryption, data verification according to a one-way function, and verification of an added electronic signature. A decryption algorithm employed by a contents-data reproducing apparatus and providing a decryption sequence is decided so as to meet the above requirement.

The decryption algorithm is designed exclusively for the contents-data reproducing apparatus. The decryption algorithm consists of a core portion and a non-core portion. The core portion is given a predetermined high level of confidentiality while the non-core portion is given a predetermined low level of confidentiality. Thus, the core portion is higher than the non-core portion in level of confidentiality. Basically, the non-core portion is irrelevant to entire processing and encryption processing. The non-core portion is designed to be implemented by the execution of corresponding software (a non-core decryption program) in a CPU within the contents-data reproducing apparatus. On the other hand, the core portion is designed to be implemented by a hardware device (for example, an electronic circuit) within the contents-data reproducing apparatus. The non-core decryption program for implementing the non-core portion is recorded on the recording medium. As previously mentioned, an example of the recording medium is a DVD.

Thus, the core portion of the decryption algorithm which is given a predetermined high level of confidentiality is implemented by the hardware device (for example, the electronic circuit). On the other hand, the non-core portion of the decryption algorithm which is given a predetermined low level of confidentiality is implemented by the execution of the corresponding software (the non-core decryption program). Linkage or interconnection between the implementation of the core portion of the decryption algorithm and the implementation of the non-core portion thereof is provided by the writing of commands, data, and statuses into registers within the hardware device (for example, the electronic circuit).

Even in the event that someone has succeeded in illegally analyzing the non-core decryption program, he or she can not get the whole of the decryption algorithm in the absence of knowledge about the existence of the hardware device (for example, the electronic circuit) for implementing the core portion of the decryption algorithm, the structure of the hardware device, the existence of the registers within the hardware device, and the processing by the hardware device. The non-core decryption program and the encrypted contents data are recorded on the recording medium. It should be noted that the recording medium storing the non-core decryption program and the encrypted contents data may be made in a known way. Examples of the recording medium are a DVD-ROM, a DVD-RAM, a DVD-R, a DVD-RW, a DVD+R, a DVD+RW, and other optical discs.

The non-core decryption program can be changed into a new version as the utilized data scrambling system (the utilized data encryption system) is changed to enhance anti-hacking performances and improve vulnerability. The decryption algorithm is updated in accordance with the change of the utilized data scrambling system. The contents-data reproducing apparatus reads out the new non-core decryption program from a recording medium, and then executes the read-out new non-core decryption program. Accordingly, the non-core decryption program to be recorded on a recording medium can be changed to update the decryption algorithm while the core portion of the decryption algorithm remains concealed.

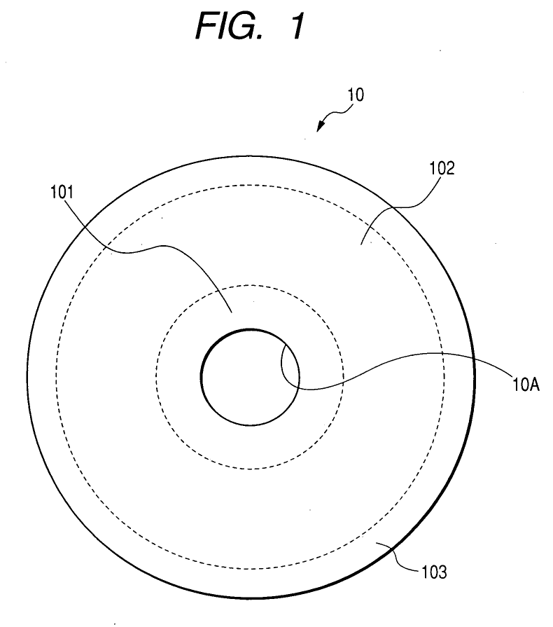

FIG. 1 shows a recording medium 10 in the first embodiment of this invention. The recording medium 10 is, for example, a DVD-ROM. The recording medium 10 may be a DVD-RAM, a DVD-RW, a DVD-R, a DVD+RW, a DVD+R, or another optical disc.

As shown in FIG. 1, the recording medium 10 takes a shape of a disc having a central circular opening 10A. Thus, the recording medium 10 has an inner circumferential edge in addition to an outer circumferential edge. The recording medium 10 is of a single-layer single-sided type. Alternatively, the recording medium 10 may be of one of a multi-layer single-sided type, a single-layer two-sided type, and a multi-layer two-sided type.

The recording medium 10 has a spiral track which extends from the inner circumferential edge toward the outer circumferential edge thereof. The spiral track is formed with, for example, pits representing a signal or data recorded on the recording medium 10.

The recording medium 10 has a recording area divided into a lead-in area 101, a user data area (a main data area) 102, and a lead-out area 103 which are successively arranged in that order as viewed in the radially outward direction. The lead-in area 101 occupies an innermost part of the recording medium 10 while the lead-out area 103 occupies an outermost part thereof. The user data area 102 extends between the lead-in area 101 and the lead-out area 103. The user data area 102 can be accessed by a user. The lead-out area 103 can be used as an auxiliary recording area after the end of the playback of the recording medium 10, that is, the contents-data reproduction from the recording medium 10.

The lead-in area 101, the user data area 102, and the lead-out area 103 are composed of prescribed unit segments (for example, sectors or clusters) assigned serial sector numbers respectively. The starting point of the lead-in area 101 corresponds to a first prescribed unit segment assigned a first sector number “00000h”, where “h” denotes hexadecimal notation. Address information representing the sector numbers is recorded on the recording medium 10 together with contents data. The address information is used to detect or identify a currently-accessed point on the recording medium 10 during playback.

The size of the lead-in area 101 is predetermined. In the case where the recording medium 10 is a DVD, the lead-in area 101 ranges from a sector number of “00000h” to a sector number of “30000h”.

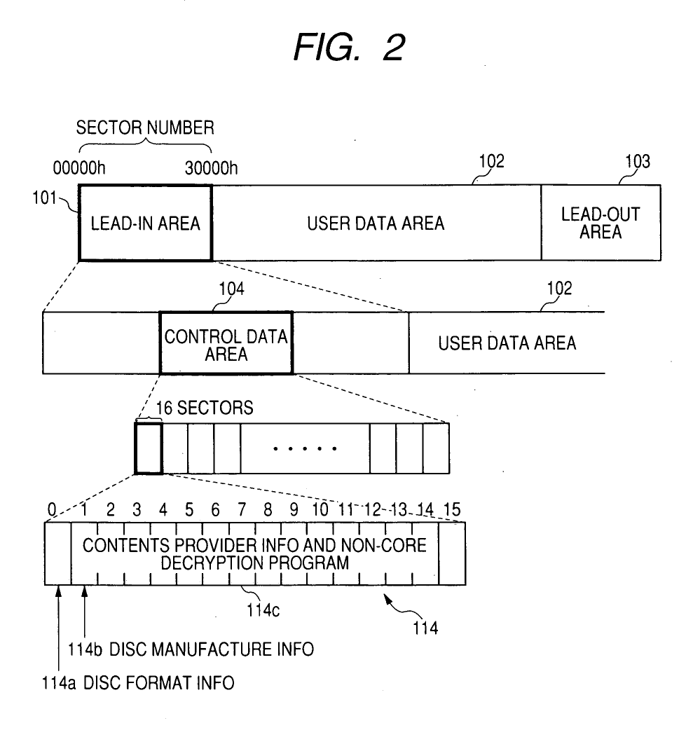

As shown in FIG. 2, the lead-in area 101 includes a control data area 104 for storing control data 114 and a non-core decryption program (a non-core decryption software program). The control data area 104 consists of segments each having 16 sectors. In each of the segments, a first sector stores recording-medium format information (disc format information) 114a and a second sector stores recording-medium manufacture information (disc manufacture information) 114b, and third to sixteenth sectors are loaded with contents provider information 114c and the non-core decryption program. Preferably, front and mid portions of the region formed by the third to sixteenth sectors are occupied by the contents provider information 114c while a rear portion thereof is occupied by the non-core decryption program. The disc format information 114a, the disc manufacture information 114b, and the contents provider information 114c constitute the control data 114. Accordingly, a set of the control data 114 and the non-core decryption program which has a size of 16 sectors is repetitively recorded on the control data area 104. The recording-medium format information 114a represents a recording format describing at least one of the type of the recording medium 10, the utilized data structure, and the type of the utilized data encryption system. Generally, the disc manufacture information 114b is used by the disc manufacturer. For example, the disc manufacture information 114b contains identification (ID) information about the manufacturer of the recording medium 10. The contents provider information 114c is designed for the contents provider. For example, the contents provider information 114c contains identification information (ID) about the provider of the contents data recorded on the recording medium 10.

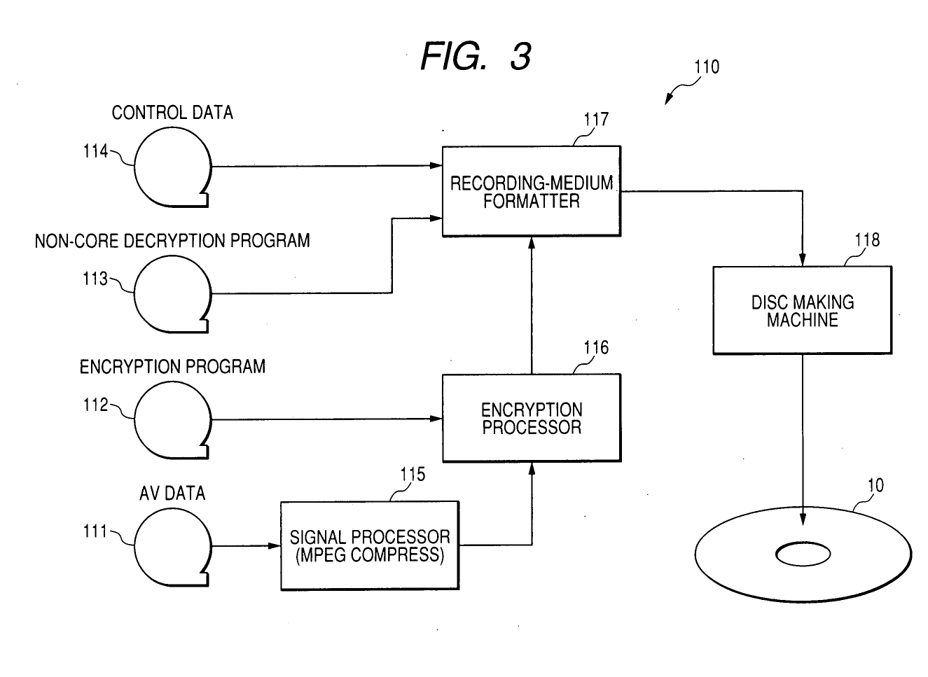

FIG. 3 shows a contents-data recording apparatus 110 in the first embodiment of this invention. The recording apparatus 110 processes contents data representing movies, AV (audio video) software, and music videos. Specifically, the recording apparatus 110 encrypts the contents data according to a prescribed encryption algorithm. Then, the recording apparatus 110 makes a recording medium 10 such as a DVD-ROM which stores the encrypted contents data. Alternatively, the recording apparatus 110 may record the encrypted contents data on a recording medium 10 such as a DVD of a writable or rewritable type.

With reference to FIG. 3, a contents provider prepares AV data (contents data) 111, an encryption program 112, a non-core decryption program (a non-core decryption software program) 113, and control data 114. The encryption program 112 is designed for encrypting the AV data 111. The non-core decryption program 113 corresponds to a non-core portion of a prescribed decryption algorithm. The non-core decryption program 113 is a computer program or a software program. The control data 114 contains recording-medium format information (disc format information) 114a, recording-medium manufacture information (disc manufacture information) 114b, and contents provider information 114c.

The recording apparatus 110 includes a signal processor 115, an encryption processor 116, a recording-medium formatter (a disc formatter) 117, and a recording-medium making machine (a disc making machine) 118.

The signal processor 115 receives the AV data (the contents data) 111. The signal processor 115 compresses and encodes the received AV data 111 according to the MPEG standards to generate compressed contents data. The signal processor 115 feeds the compressed contents data to the encryption processor 116.

The encryption processor 116 receives the encryption program 112. The encryption processor 116 encrypts (scrambles) the compressed contents data in accordance with the encryption program 112 to generate encrypted (scrambled) contents data. This encryption enhances the confidentiality of the original contents data. The encryption processor 116 feeds the encrypted contents data to the recording-medium formatter 117.

The recording-medium formatter 117 receives the non-core decryption program 113 and the control data 114. The recording-medium formatter 117 combines the encrypted contents data, the non-core decryption program 113, and the control data 114 into a prescribed format which corresponds to a recording medium 10, and which is designed so that the non-core decryption program 113 and the control data 114 will be assigned to a control data area 104 of the recording medium 10 while the encrypted contents data will be assigned to a user data area 102 of the recording medium 10. The recording-medium formatter 117 feeds the resultant formatted data to the recording-medium making machine 118.

The recording-medium making machine 118 produces a recording medium 10 such as a DVD-ROM which stores the formatted data. The produced recording medium 10 has a user data area 102 and a control data area 104. The user data area 102 stores the encrypted contents data. The control data area 104 stores the non-core decryption program 113 and the control data 114. As previously mentioned, the control data 114 contains the recording-medium format information 114a, the recording-medium manufacture information 114b, and the contents provider information 114c. Each of 16-sector segments constituting the control data area 104 stores the recording-medium format information 114a, the recording-medium manufacture information 114b, the contents provider information 114c, and the non-core decryption program 113. In each of the 16-sector segments, a first sector stores the recording-medium format information 114a and a second sector stores the recording-medium manufacture information 114b, and third to sixteenth sectors are loaded with the contents provider information 114c and the non-core decryption program 113. Preferably, front and mid portions of the region formed by the third to sixteenth sectors are occupied by the contents provider information 114c while a rear portion thereof is occupied by the non-core decryption program 113.

A contents-data reproducing apparatus reads out the non-core decryption program 113 from the recording medium 10, and uses the non-core decryption program 113 only therein. The reproducing apparatus inhibits a user from accessing and utilizing data recorded on areas of the recording medium 10 other than the user data area 102. Therefore, it is difficult for the user to obtain the non-core decryption program 113 from the recording medium 10 through the use of the reproducing apparatus.

In the case where the recording medium 10 is a DVD-RAM, a DVD-R, a DVD-RW, a DVD+R, a DVD+RW, or another writable or rewritable optical disc, a recording-medium writer (a recording-medium recorder) replaces the recording-medium making machine 118. The recording-medium writer receives the formatted data from the recording-medium formatter 117. The recording-medium writer records the formatted data on the recording medium 10. Specifically, the recording-medium writer records the control data 114 and the non-core decryption program 113 in the formatted data on each of 16-sector segments in a control data area 104 of the recording medium 10. Then, the recording-medium writer records the encrypted contents data in the formatted data on a user data area 102 of the recording medium 10. Finally, the recording-medium writer records prescribed data on a lead-out area 103 of the recording medium 10.

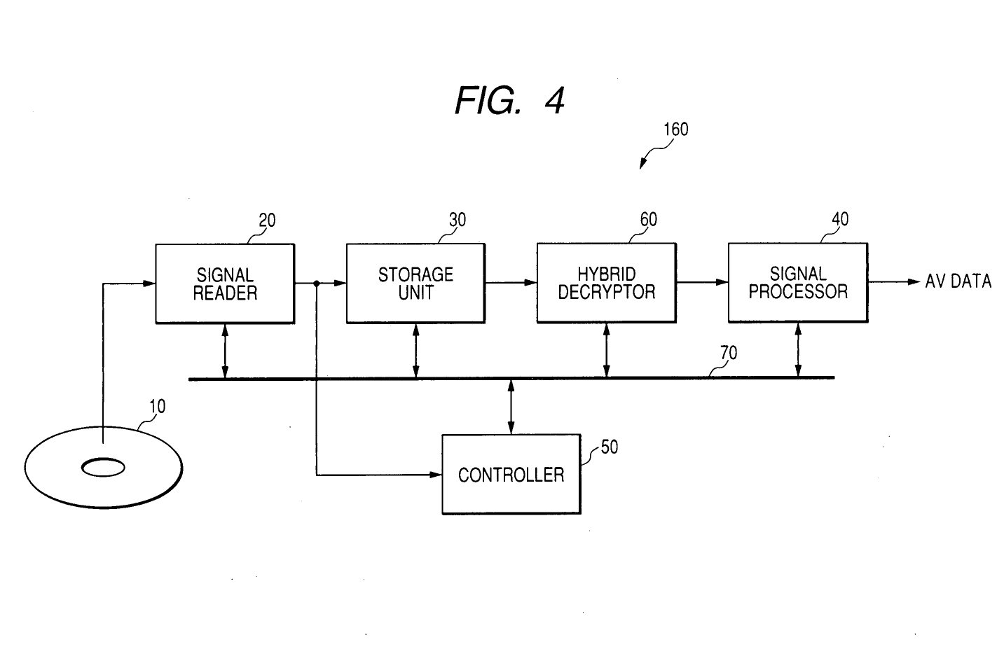

FIG. 4 shows a contents-data reproducing apparatus 160 in the first embodiment of this invention. The reproducing apparatus 160 includes a signal reader 20, a storage unit 30, a signal processor 40, a controller 50, and a hybrid decryptor 60 which are connected via a bus 70. The devices 20, 30, 40, and 60 are controlled by the controller 50.

The signal reader 20 reads out encrypted contents data, a non-core decryption program 113, and control data 114 from a recording medium 10 while being controlled by the controller 50.

The encrypted contents data is sent from the signal reader 20 to the storage unit 30 via an exclusive connection line, and is stored in the storage unit 30 while the devices 20 and 30 are controlled by the controller 50 via the bus 70. The non-core decryption program 113 is sent from the signal reader 20 to the hybrid decryptor 60 via an exclusive connection line while the devices 20 and 60 are controlled by the controller 50 via the bus 70. The control data 114 is sent from the signal reader 20 to the controller 50 via the bus 70 while the signal reader 20 is controlled by the controller 50 via the bus 70. The controller 50 operates in response to the control data 114.

The encrypted contents data is sent from the storage unit 30 to the hybrid decryptor 60 via an exclusive connection line while the devices 30 and 60 are controlled by the controller 50 via the bus 70. Specifically, the encrypted contents data in the storage unit 30 is divided into blocks which are sequentially sent to the hybrid decryptor 60.

The hybrid decryptor 60 is controlled by the controller 50 to decrypt (descramble) every block of the encrypted contents data into a block of compressed contents data according to a decryption algorithm, a part of which is provided by the non-core decryption program 113. The decryption by the hybrid decryptor 60 is inverse with respect to the encryption by the encryption processor 116 in the recording apparatus 110 (see FIG. 3).

Every block of the compressed contents data is sent from the hybrid decryptor 60 to the signal processor 40 via an exclusive connection line while the devices 40 and 60 are controlled by the controller 50 via the bus 70.

The signal processor 40 is controlled by the controller 50 to decode and expand the compressed contents data according to the MPEG standards to reproduce original AV data (original contents data). The signal processor 40 outputs the reproduced AV data while being controlled by the controller 50.

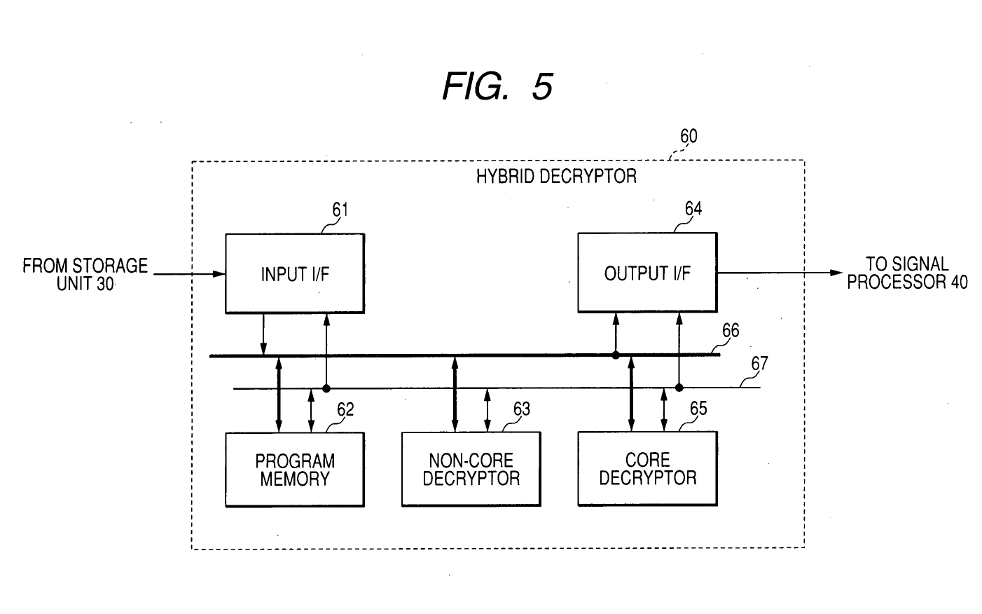

As shown in FIG. 5, the hybrid decryptor 60 includes an input interface 61, a program memory 62, a non-core decryptor 63, an output interface 64, and a core decryptor 65 which are connected via a data bus 66 and a control line 67. For example, the data bus 66 and the control line 67 form a portion of the bus 70 in FIG. 4.

The input interface 61 receives the encrypted contents data from the storage unit 30. The program memory 62 stores the non-core decryption program 113 which is sent by the controller 50 from the signal reader 20 to the program memory 62 via the bus 70. Preferably, the non-core decryptor 63 is formed by a CPU. A combination of the non-core decryptor 63 and the core decryptor 65 receives every block of the encrypted contents data from the input interface 61, and decrypts (descrambles) the block of the encrypted contents data into a block of the compressed contents data by implementing the decryption algorithm. The decryption algorithm consists of a core portion and a non-core portion. The core portion is given a predetermined high level of confidentiality while the non-core portion is given a predetermined low level of confidentiality. The non-core decryptor 63 refers to the non-core decryption program 113 in the program memory 62, and implements the non-core portion of the decryption algorithm by executing the non-core decryption program 113. The core decryptor 65 implements the core portion of the decryption algorithm. The core decryptor 65 is formed by a hardware device including, for example, an electronic circuit. The combination of the non-core decryptor 63 and the core decryptor 65 sends every block of the compressed contents data to the output interface 64. The output interface 64 passes the compressed contents data to the signal processor 40.

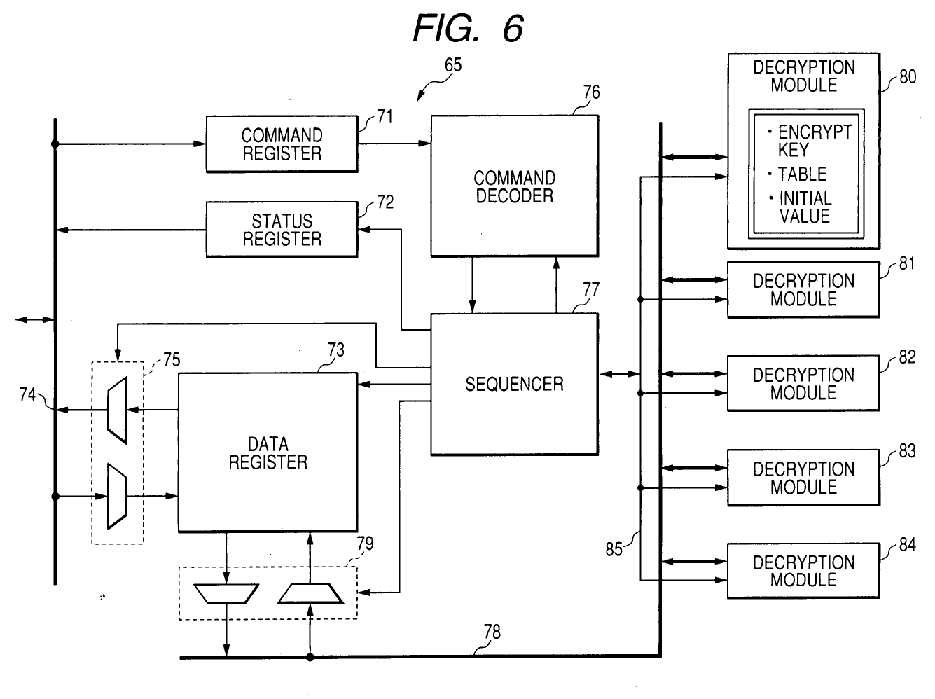

As shown in FIG. 6, the core decryptor 65 includes a command register 71, a status register 72, a data register 73, an external bus 74, an external data selector 75, a command decoder 76, a sequencer 77, an internal bus 78, an internal data selector 79, and one or more decryption modules (for example, decryption modules 80, 81, 82, 83, and 84).

The command register 71 stores a command which is a code word representing a type of data decryption processing which can be selected from plural different types. The status register 72 stores a status of the data decryption processing. The data register 73 stores data inputted to the core decryptor 65, and data to be outputted from the core decryptor 65. The external bus 74 transmits a command from an external device to the command register 71. The external bus 74 transmits a status from the status register 72 to an external device. The external bus 74 and the external data selector 75 send data between the data register 73 and external devices. For example, the external bus 74 forms portions of the data bus 66 and the control line 67 in FIG. 5. The external data selector 75 serves to select data sent between the data register 73 and the external bus 74. The command decoder 76 receives a command from the command register 71, and decodes the received command to decide a data decryption processing sequence. The sequencer 77 controls the decryption modules 80-84 in accordance with the data decryption processing sequence decided by the command decoder 76. The internal data selector 79 and the decryption modules 80-84 are connected via the internal bus 78. The internal data selector 79 serves to select data sent between the data register 73 and the internal bus 78. The decryption modules 80-84 are designed to perform different types of data decryption processing, respectively. Alternatively, the decryption modules 80-84 are separated into groups designed to perform different types of data decryption processing respectively. The command in the command register 71 represents one among the types of the data decryption processing performed by the respective decryption modules 80-84 or the respective groups of the decryption modules 80-84. Each of the decryption modules 80-84 or each of the groups of the decryption modules 80-84 implements at least partially the core portion of the decryption algorithm. There may be only one decryption module. The sequencer 77 is connected with the decryption modules 80-84 via a module control line 85. Each of the decryption modules 80-84 is formed by an electronic circuit, that is, a hardware device. Each of the decryption modules 80-84 has an encryption key (a decryption key), a lookup table, and an initial value which are provided in advance or on an embedded basis. The external bus 74 and the internal bus 78 are physically separate from each other. Data partially decrypted by the decryption modules 80-84 is propagated only along the internal bus 78 while being prevented from leaking to the external bus 74.

With reference to FIGS. 4, 5, and 6, the reproducing apparatus 160 operates as follows. At an initial stage of operation of the reproducing apparatus 160, the signal reader 20 reads out the non-core decryption program 113 from the control data area 104 in the lead-in area 101 of the recording medium 10 while being controlled by the controller 50. The read-out non-core decryption program 113 is sent from the signal reader 20 to the hybrid decryptor 60 before being stored in the program memory 62 within the hybrid decryptor 60. The non-core decryptor 63 is designed to implement the non-core portion of the decryption algorithm by executing the non-core decryption program 113 in the program memory 62.

Then, the controller 50 starts a contents reproduction mode of operation of the reproducing apparatus 160 in response to a trigger caused by operation of a user interface (not shown) by a user. During the contents reproduction mode of operation, the signal reader 20 reads out the encrypted contents data from the user data area 102 of the recording medium 10. The read-out encrypted contents data is stored into the storage unit 30 from the signal reader 20 at a rate higher than a rate of data processing by the signal processor 40. The encrypted contents data is sent from the storage unit 30 to the hybrid decryptor 60 at a rate lower than the rate of the data transfer from the signal reader 20 to the data storage unit 30. As previously mentioned, blocks of the encrypted contents data are sequentially sent from the storage unit 30 to the hybrid decryptor 60 before being sequentially processed by the hybrid decryptor 60.

The controller 50 monitors the amount of the encrypted contents data in the storage unit 30. Furthermore, the controller 50 compares the monitored amount with a prescribed value to decide whether or not the monitored amount reaches the prescribed value. In addition, the controller 50 compares the monitored amount with a prescribed range to decide whether or not the monitored amount reaches the lower limit of the prescribed range, and decide whether or not the monitored amount reaches the upper limit of the prescribed range. When the monitored amount of the encrypted contents data in the storage unit 30 increases to the prescribed value, the controller 50 suspends the read-out of the encrypted contents data from the recording medium 10 by the signal reader 20. Thereafter, the monitored amount of the encrypted contents data in the storage unit 30 decreases since the encrypted contents data remains sent from the storage unit 30 to the hybrid decryptor 60. When the monitored amount of the encrypted contents data in the storage unit 30 decreases to the lower limit of the prescribed range, the controller 50 restarts the read-out of the encrypted contents data from the recording medium 10 by the signal reader 20. As a result, the monitored amount of the encrypted contents data in the storage unit 30 increases again. Therefore, the read-out of the encrypted contents data from the recording medium 10 by the signal reader 20 is intermittent.

When the monitored amount of the encrypted contents data in the storage unit 30 increases to the prescribed value, the controller 50 commands the non-core decryptor 63 in the hybrid decryptor 60 to start executing the non-core decryption program 113 in the program memory 62.

Every block of the encrypted contents data is read out from the storage unit 30 before being sent to the combination of the non-core decryptor 63 and the core decryptor 65 via the input interface 61 and the data bus 66. The non-core decryptor 63 partially decrypts the encrypted contents data into partially-decrypted encrypted contents data by executing the non-core decryption program 113 in the program memory 62.

Once the monitored amount of the encrypted contents data in the storage unit 30 increases to the upper limit of the prescribed range, the controller 50 commands the combination of the non-core decryptor 63 and the core decryptor 65 to fully decrypt a block of the encrypted contents data. The decryption by the non-core decryptor 63 is carried out by executing the non-core decryption program 113 in the program memory 62. The decryption by the core decryptor 65 is on a hardware processing basis since the core decryptor 65 is formed by a hardware device, for example, an electronic circuit as previously mentioned. The decryption of the encrypted contents data by the combination of the non-core decryptor 63 and the core decryptor 65 is substantially continuous while the read-out of the encrypted contents data from the recording medium 10 by the signal reader 20 is intermittent.

The core decryptor 65 which is formed by a hardware device implements the core portion of the decryption algorithm. The non-core decryption program 113 is designed to implement the non-core portion of the decryption algorithm. Specifically, the non-core decryption program 113 is designed so that decryption command information for commanding the core decryptor 65 to start the data decryption processing will be written into the command register 71, and data applied as an input to the data decryption processing will be written into the data register 73, and that a status set in the status register 72 will be monitored at a stage of the completion of the writing of the decryption command information into the command register 71. The data applied as an input to the data decryption processing indicates a numerical value. The decryption command information includes a code word representing a type of the data decryption processing.

In the core decryptor 65, the data applied as an input to the data decryption processing is sent from the data register 73 to the decryption modules 80-84 via the internal data selector 79 and the internal bus 78, and is processed and decrypted by the decryption modules 80-84 in a designated sequence. The processing-resultant data (the decrypted data) is sent from the decryption modules 80-84 to the data register 73 via the internal bus 78 and the internal data selector 79 before being written into the data register 73. Thus, the decryption processing of the data applied as an input is executed in an inner part of the core decryptor 65. Accordingly, the decryption processing of the data applied as an input is concealed from the outside of the core decryptor 65.

When the decryption processing of the data applied as an input ends, the core decryptor 65 sends an interrupt signal to the non-core decryptor 63 via the control line 67 to notify an end of the data decryption processing to the non-core decryptor 63. The non-core decryptor 63 is thus informed by the interrupt signal that the implementation of the core portion of the decryption algorithm by the core decryptor 65 ends. Then, the non-core decryptor 63 executes a remaining portion of the non-core decryption program 113 in the program memory 62.

Since the core portion of the decryption algorithm is implemented by the inner part of the core decryptor 65, it is difficult to access the core portion of the decryption algorithm from the outside of the core decryptor 65. Therefore, it is difficult to illegally analyze the core portion of the decryption algorithm.

The hybrid decryptor 60 decrypts (descrambles) the encrypted contents data which is sent from the storage unit 30 into compressed contents data according to the decryption algorithm. The compressed contents data is sent from the hybrid decryptor 60 to the signal processor 40. The signal processor 40 decodes and expands the compressed contents data according to the MPEG standards to reproduce original AV data (original contents data). The signal processor 40 outputs the reproduced AV data.

The controller 50 controls the signal reader 20, the storage unit 30, and the signal processor 40 in connection with the decryption by the hybrid decryptor 60 so that the monitored amount of the encrypted contents data in the storage unit 30 will be maintained in the prescribed range.

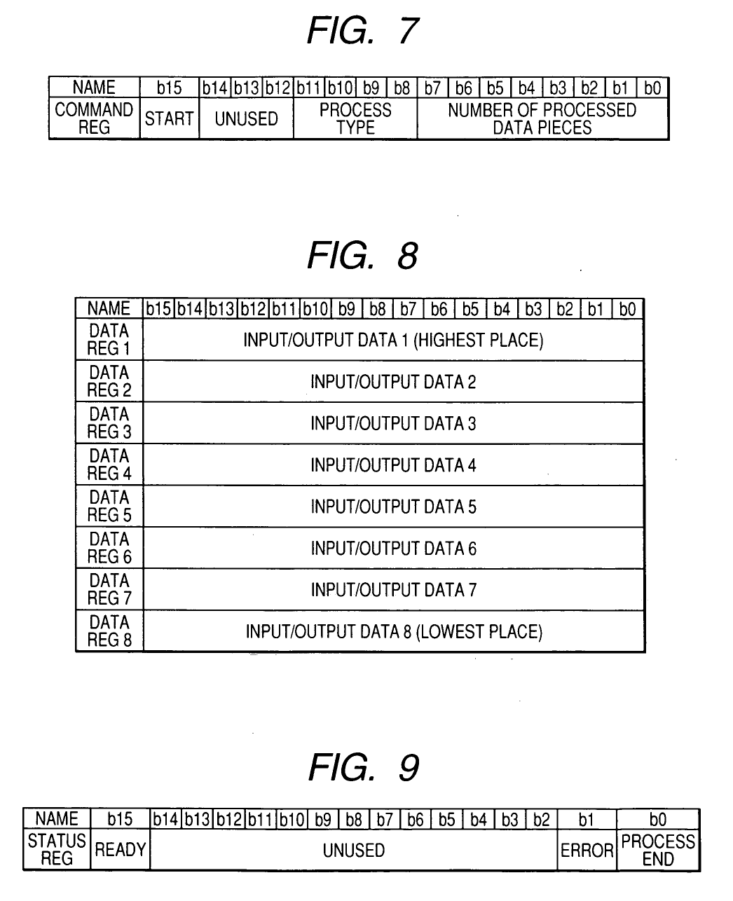

FIG. 7 shows an example of the format of a command written into the command register 71. The command is a code word representing a type of data decryption processing. As shown in FIG. 7, the command is composed of 16 bits denoted by b15, b14, . . . , b1, and b0 respectively. The highest bit b15 is a start bit for commanding the start of the data decryption processing. The bits b14-b12 are unused. The bits b11-b8 represent the type of the data decryption processing which corresponds to the core portion of the decryption algorithm or a segment of the core portion of the decryption algorithm. The 8 lower bits b7-b0 represent the size of a block of data which is an object to be processed. Specifically, the bits b7-b0 represent the number of 16-bit pieces (16-bit words) constituting the data block.

FIG. 8 shows an example of the format of data stored in the data register 73 which is data applied as an input to the data decryption processing and data obtained as an output from the data decryption processing. The data stored in the data register 73 is composed of up to 128 bits. The data register 73 consists of 8 sub registers (banks) each having a size of 16 bits. The sub registers are numbered “1”, “2”, . . . , and “8”, respectively.

FIG. 9 shows an example of the format of a status set in the status register 72. The status is composed of 16 bits denoted by b15, b14, . . . , b1, and b0 respectively. The highest bit b15 is assigned to a ready status for indicating that the core decryptor 65 is usable. The bits b14-b2 are unused. The bit b1 is assigned to an error status for indicating the occurrence of an error in operation of the core decryptor 65. The bit b0 is assigned to a data decryption processing end status for indicating that the core decryptor 65 terminates the data decryption processing.

An example of operation of the non-core decryptor 63 and the core decryptor 65 in the hybrid decryptor 60 is as follows. During the implementation of the non-core portion of the decryption algorithm by executing the non-core decryption program 113 transferred from the recording medium 10 to the program memory 62, when a timing for implementing the core portion of the decryption algorithm or each of segments of the core portion of the decryption algorithm has come, the non-core decryptor 63 loads the data register 73 of the core decryptor 65 with data applied as an input to data decryption processing. Furthermore, in this case, the non-core decryptor 63 writes a command into the command register 71. Specifically, the non-core decryptor 63 loads the portion of the command register 71, which corresponds to the bits b11-b8, with a 4-bit code word representing the type of the data decryption processing. In addition, the non-core decryptor 63 writes “1” into the portion of the command register 71 which corresponds to the highest bit b15, that is, the start bit.

In the core decryptor 65, the command decoder 76 detects that the highest bit b 15, that is, the start bit in the command register 71 changes to “1”. Upon the detection of the change of the start bit to “1”, the command decoder 76 takes in the 4-bit code word from the portion of the command register 71 which corresponds to the bits b11-b8. The 4-bit code word represents the type of the data decryption processing. The command decoder 76 decodes the 4-bit code word to generate information indicative of a condition for a branch (a jump) accorded with the data decryption processing type represented by the 4-bit code word. The command decoder 76 notifies the condition for the branch to the sequencer 77, thereby making the sequencer 77 start a corresponding state transition procedure and hence starting the data decryption processing by the inner part of the core decryptor 65.

The sequencer 77 controls the data register 73 and the internal data selector 79 so that the data applied as an input to the data decryption processing will be transferred from the data register 73 onto the internal bus 78. The sequencer 77 activates at least one of the decryption modules 80-84 which corresponds to the notified condition for the branch and hence accords with the data decryption processing type represented by the 4-bit code word decoded by the command decoder 76. The activated one of the decryption module 80-84 receives the data applied as an input from the internal bus 78, and processes and at least partially decrypts the input data into output data while executing the data decryption processing to implement the core portion of the decryption algorithm or the segment of the core portion of the decryption algorithm.

As previously mentioned, each of the decryption modules 80-84 is formed by an electronic circuit. Each of the decryption modules 80-84 has an encryption key (a decryption key), a lookup table, and an initial value which are provided in advance or on an embedded basis. The activated one of the decryption module 80-84 processes and at least partially decrypts the input data into output data in response to the related encryption key, the related lookup table, and the related initial value while implementing the core portion of the decryption algorithm or the segment of the core portion of the decryption algorithm.

If necessary, intermediately processed data (intermediately decrypted data) is transferred between the activated one of the decryption modules 80-84 and another via only the internal bus 78.

Upon the completion of the data decryption processing of the input data, the activated one of the decryption modules 80-84 sends a processing end signal to the sequencer 77 via the module control line 85. In response to the processing end signal, the sequencer 77 transitions to a state of controlling the activated one of the decryption modules 80-84 to discharge the output data (the result of the data decryption processing or the at least partially decrypted data) onto the internal bus 78. Then, the sequencer 77 controls the data register 73 and the internal data selector 79 so that the output data will be written into the data register 73 from the internal bus 78.

Subsequently, the sequencer 77 controls the data register 73 and the external data selector 75 so that the output data (the decrypted data) will be transferred from the data register 73 to the external bus 74. The output data is propagated along the external bus 74 to the output interface 64 or the non-core decryptor 63. In addition, the sequencer 77 sets a processing completion status (a normal end status) in the status register 72 to terminate the data decryption processing of the input data. Thereby, the sequencer 77 sends an interrupt signal to the non-core decryptor 63 via the status register 72 and the external bus 74 to notify an end of the data decryption processing to the non-core decryptor 63.

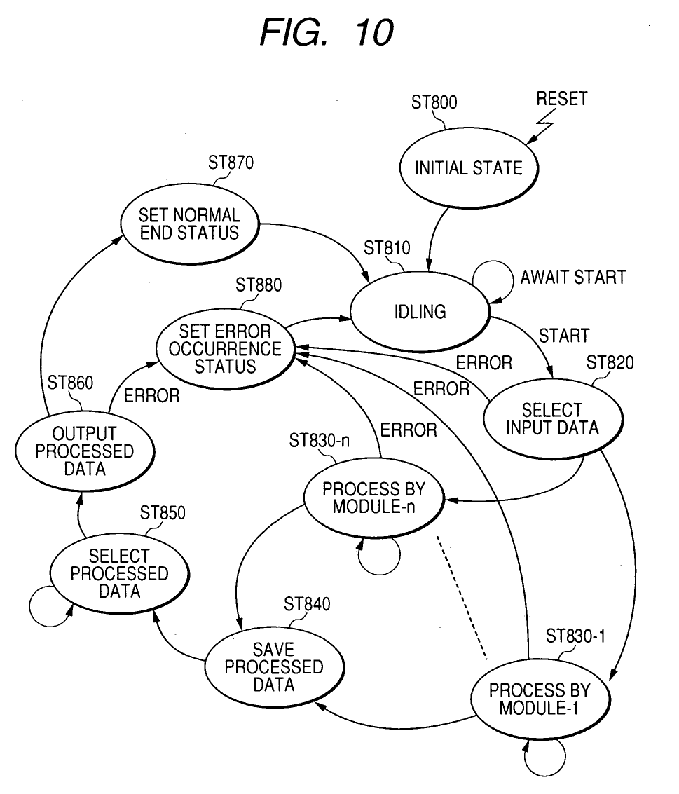

FIG. 10 shows an example of state transitions of the sequencer 77. With reference to FIG. 10, the sequencer 77 transitions to an initial state ST800 in response to a reset signal fed from an external device. In the initial state ST800, the sequencer 77 sets an initial status in the status register 72. Then, the sequencer 77 transitions from the initial state ST800 to an idling state ST810 for awaiting start.

When start is made, the sequencer 77 transitions from the idling state ST810 to a state ST820. In the state ST820, the sequencer 77 controls the data register 73 so that the input data (the data applied as an input to data decryption processing) will be selected. Furthermore, the sequencer 77 controls the data register 73 and the internal data selector 79 so that the input data will be transferred from the data register 73 onto the internal bus 78. Then, the sequencer 77 makes a branch to one of the decryption modules 80-84 in accordance with a data decryption processing type represented by a 4-bit code word decoded by the command decoder 76, and sends a decryption start command to the present decryption module. Thus, the sequencer 77 transitions from the state ST820 to one of states ST830-1, . . . , and ST830-n corresponding to the respective decryption modules 80-84.

In the above-mentioned one of the states ST830-1, . . . , and ST830-n, the sequencer 77 activates at least one of the decryption modules 80-84 which corresponds to the notified condition for the branch and hence accords with the data decryption processing type represented by the 4-bit code word decoded by the command decoder 76. The activated decryption module receives the input data from the internal bus 78, and processes and at least partially decrypts the input data into output data while executing the data decryption processing to implement the core portion of the decryption algorithm or a segment of the core portion of the decryption algorithm. If necessary, the activated decryption module sends intermediately processed data (intermediately decrypted data) to another decryption module via the internal bus 78. Upon the completion of the data decryption processing of the input data, the activated decryption module sends a processing end signal to the sequencer 77. In response to the processing end signal, the sequencer 77 transitions from the above-mentioned one of the states ST830-1, . . . , and ST830-n to a state ST840.

In the state ST840, the sequencer 77 controls the activated decryption module to discharge the output data (the result of the data decryption processing or the at least partially decrypted data) onto the internal bus 78. Then, the sequencer 77 controls the data register 73 and the internal data selector 79 so that the output data will be written into and saved in the data register 73 from the internal bus 78. Then, the sequencer 77 transitions from the state ST840 to a state ST850.

In the state ST850, the sequencer 77 controls the data register 73 so that the output data (the decrypted data) will be selected. Then, the sequencer 77 transitions from the state ST850 to a state ST860.

In the state ST860, the sequencer 77 controls the data register 73 and the external data selector 75 so that the output data (the decrypted data) will be transferred from the data register 73 to the external bus 74. Then, the sequencer 77 transitions from the state ST860 to a state ST870.

In the state ST870, the sequencer 77 sets a processing completion status (a normal end status) in the status register 72 to terminate the data decryption processing of the present input data. Thereby, the sequencer 77 sends an interrupt signal to the non-core decryptor 63 via the status register 72 and the external bus 74 to notify an end of the data decryption processing to the non-core decryptor 63. Then, the sequencer 77 returns from the state ST870 to the idling state ST810 to start the data decryption processing of the next input data.

When an error occurs in the operation of the sequencer 77 and the decryption modules 80-84, the sequencer 77 transitions to a state ST880 in which the sequencer 77 sets an error occurrence status in the status register 72. Then, the sequencer 77 returns from the state ST880 to the idling state ST810 to restart the data decryption processing of the present input data.

In response to the interrupt signal from the sequencer 77, the non-core decryptor 63 checks whether or not the normal end status (the processing completion status) is in the status register 72. When the normal end status is in the status register 72, the non-core decryptor 63 starts executing a remaining portion of the non-core decryption program 113.

During the decryption of every block of the encrypted data by the hybrid decryptor 60, the data decryption processing by the non-core decryptor 63 and the data decryption processing by the core decryptor 65 may alternate a plurality of times. In this case, every block of the encrypted data is subjected alternately to the decryption processing by the non-core decryptor 63 and the decryption processing by the core decryptor 65. Every switch between the decryption processing by the non-core decryptor 63 and the decryption processing by the core decryptor 65 is provided by an interrupt. The non-core decryptor 63 sequentially executes segments of the non-core decryption program 113 while the core decryptor 65 sequentially implements the segments of the core portion of the decryption algorithm.

As previously mentioned, the data applied as an input to the data decryption processing (the input data) is sent from the data register 73 to at least one of the decryption modules 80-84 via the internal bus 78. Then, the input data is processed and decrypted into the output data (the decrypted data or the processing-resultant data) by the above-mentioned one of the decryption modules 80-84. The output data is sent from the above-mentioned one of the decryption modules 80-84 to the data register 73 via the internal bus 78 before being written into the data register 73.

In the core decryptor 65, the external bus 74 and the internal bus 78 are physically separate from each other. The decryption modules 80-84 which connect with the internal bus 78 are physically separate from the external bus 74. Therefore, it is difficult to access the internal bus 78 and the decryption modules 80-84 from the outside of the core decryptor 65. If necessary, intermediately decrypted data is transferred among the decryption modules 80-84 via only the internal bus 78. The data register 73 and the internal data selector 79 block an access to the intermediately decrypted data from the outside of the core decryptor 65. Accordingly, it is difficult to detect the intermediately decrypted data from the outside of the core decryptor 65.

As previously mentioned, the core portion of the decryption algorithm is given a predetermined high level of confidentiality while the non-core portion thereof is given a predetermined low level of confidentiality. The non-core decryption program 113 is read out from the recording medium 10 before being stored into the program memory 62 within the hybrid decryptor 60. The non-core portion of the decryption algorithm is implemented by the execution of the non-core decryption program 113 by the non-core decryptor 63. The hybrid decryptor 60 includes the core decryptor 65 which has the decryption modules 80-84 formed by electronic circuits (hardware devices). The core portion of the decryption algorithm is implemented by the decryption modules 80-84. It is difficult to analyze the decryption modules 80-84 since they are formed by the hardware devices.

The non-core decryption program 113 which corresponds to the non-core portion of the decryption algorithm is recorded on the recording medium 10. The non-core decryption program 113 is read out from the recording medium 10 before being executed by the non-core decryptor 63. Although the core portion of the decryption algorithm remains the same, the decryption algorithm changes as the non-core portion thereof or the non-core decryption program 113 changes. Therefore, the decryption algorithm can easily be replaced with new one or updated into a new version by changing the non-core decryption program 113. A change in the non-core decryption program 113 enables the reproducing apparatus 160 to efficiently follow one selected from different encryption/decryption systems utilizing different encryption/decryption algorithms respectively. Furthermore, a change in the non-core decryption program 113 enables the reproducing apparatus 160 to follow a new encryption/decryption system without modification of the core decryptor 65.

As previously mentioned, the core portion of the decryption algorithm is given a predetermined high level of confidentiality. The core portion of the decryption algorithm is implemented by the decryption modules 80-84 within the core decryptor 65 in the hybrid decryptor 60. The decryption modules 80-84 are formed by the electronic circuits (the hardware circuits). It is difficult to analyze the decryption modules 80-84 since there are formed by the hardware circuits. Accordingly, it is difficult to analyze the core portion of the decryption algorithm. Thus, it is possible to provide anti-tamper performances higher than those occurring in an assumed case where the whole of the decryption algorithm is implemented by executing a corresponding decryption program.

In the core decryptor 65, the external bus 74 and the internal bus 78 are physically separate from each other. The decryption modules 80-84 which connect with the internal bus 78 are physically separate from the external bus 74. If necessary, intermediately decrypted data is transferred among the decryption modules 80-84 via only the internal bus 78. The intermediately decrypted data is prevented from leaking to the external bus 74. Accordingly, it is difficult to detect the intermediately decrypted data from the outside of the core decryptor 65. Thus, it is possible to provide higher anti-tamper performances.

As previously mentioned, the execution of the non-core decryption program 113 implements the non-core portion of the decryption algorithm. The non-core decryption program 113 is recorded on the recording medium 10. The non-core decryption program 113 may be varied from medium to medium, from medium type to medium type, or from medium group to medium group. A change in the non-core decryption program 113 makes it possible to update the decryption algorithm, the encryption/decryption system, and the copyright protection software. Furthermore, a change in the non-core decryption program 113 enables the reproducing apparatus 160 to follow a new decryption algorithm, a new encryption/decryption system, and new copyright protection software without modification of the core decryptor 65. This is advantageous in allowing the reproducing apparatus 160 to maintain high security and reliable anti-hacking performances through the updating of the decryption algorithm, the encryption/decryption system, and the copyright protection software.

### Second Embodiment

A second embodiment of this invention is similar to the first embodiment thereof except for design changes mentioned hereafter.

According to the second embodiment of this invention, a specified area of the recording medium 10 stores different non-core decryption programs 113 corresponding to different decryption algorithms respectively. The specified area is located in, for example, the control data area 104 of the recording medium 10.

The user data area 102 of the recording medium 10 stores the encrypted contents data. The recording medium 10 has a management area and a playback control information area. Data or a flag of an identifier indicating which of the decryption algorithms should be selected is stored in a management file in the management area or a navigation file in the playback control information area.

The reproducing apparatus 160 reads out the identifier from the recording medium 10. In the reproducing apparatus 160, the read-out identifier is sent from the signal reader 20 to the controller 50. The controller 50 refers to the read-out identifier, and thereby detects one of the decryption algorithms which should be selected. Then, the controller 50 decides one of the non-core decryption programs 113 which corresponds to the decryption algorithm to be selected. Subsequently, the controller 50 controls the signal reader 20 to read out the decided non-core decryption program 113. The read-out non-core decryption program 113 is sent from the signal reader 20 before being stored into the program memory 62 of the hybrid decryptor 60.

Alternatively, the reproducing apparatus 160 may read out all the non-core decryption programs 113 from the recording medium 10 at once. In this case, the read-out non-core decryption programs 113 are sent from the signal reader 20 before being stored into the program memory 62. The hybrid decryptor 60 is notified of the read-out identifier. The hybrid decryptor 60 decides which of the non-core decryption programs 113 in the program memory 62 should be selected on the basis of the read-out identifier. In accordance with the result of the decision, the hybrid decryptor 60 selects one from the non-core decryption programs 113. In the hybrid decryptor 60, the selected non-core decryption program 113 is executed.

The identifier may be replaced by a control signal indicating a desired order in which the non-core decryption programs 113 should be executed. In this case, the reproducing apparatus 160 reads out the control signal from the recording medium 10. The hybrid decryptor 60 is notified of the read-out control signal. The reproducing apparatus 160 reads out all the non-core decryption programs 113 from the recording medium 10 at once. The read-out non-core decryption programs 113 are sent from the signal reader 20 before being stored into the program memory 62. The hybrid decryptor 60 sequentially selects and executes the non-core decryption programs 113 in an order equal to the desired order indicated by the control signal.

Alternatively, in the reproducing apparatus 160, the read-out control signal may be sent from the signal reader 20 to the controller 50. In this case, the controller 50 controls the signal reader 20 to sequentially read out the non-core decryption programs 113 in an order equal to the desired order indicated by the control signal. The read-out non-core decryption programs 113 are sequentially sent from the signal reader 20 before being sequentially stored into the program memory 62 of the hybrid decryptor 60. In the hybrid decryptor 60, the non-core decryption programs 113 are sequentially executed.

### Third Embodiment

A third embodiment of this invention is similar to the first embodiment thereof except for design changes mentioned hereafter. The third embodiment of this invention utilizes a copyright protection scheme based on the CPPM (Content Protection for Pre-recorded Media) system. The CPPM system may be replaced by the CPRM (Content Protection for Recordable Media) system. In the third embodiment of this invention, the recording medium 10 is a DVD-Audio disc.

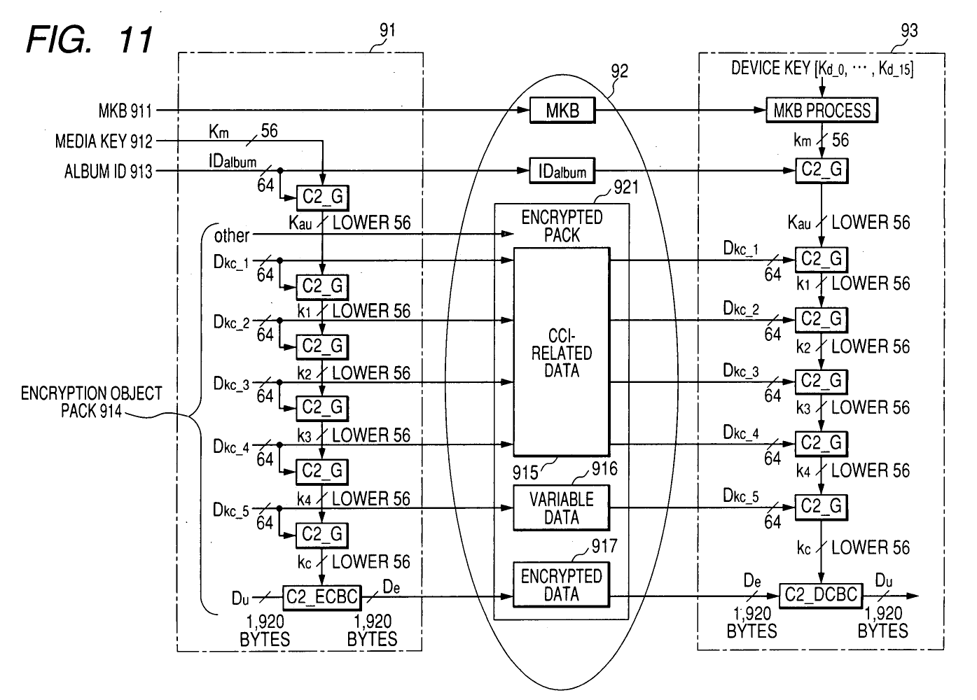

FIG. 11 shows a disc making equipment 91, a DVD-Audio disc 92, and a contents-data reproducing apparatus 93 according to the third embodiment of this invention. The disc making equipment 91 corresponds to the recording apparatus 110 in FIG. 3. Preferably, the disc making equipment 91 is provided in the recording apparatus 110. The disc making equipment 91 performs encryption based on the CPPM system for every data pack. The DVD-Audio disc 92 corresponds to the recording medium 10 in FIGS. 3 and 4. Preferably, the DVD-Audio disc 92 forms the recording medium 10. The DVD-Audio disc 92 is protected by the CPPM system. The reproducing apparatus 93 corresponds to the reproducing apparatus 160 in FIG. 4. Preferably, the reproducing apparatus 93 is provided in the reproducing apparatus 160. The reproducing apparatus 93 performs decryption based on the CPPM system for every data pack.

In the disc making equipment 91, data representative of a media key block (MKB) 911, data representative of a media key (Km) 912, data representative of album ID (ID_{album}) 913, and data being an encryption object pack 914 are prepared. The disc making equipment 91 produces the DVD-Audio disc 92 which stores the data of the media block key (MKB) 911, the data of the album ID (ID_{album}) 913, and an encrypted pack 921. The encrypted pack 921 has a portion 915 loaded with CCI-related data, a portion 916 loaded with variable data, and a portion 917 loaded with encrypted data, where CCI is short for “copy control information”.

In the disc making equipment 91, an intermediate key Kau is generated from the media key 912 and the album ID (ID_{album}) 913 through operation using the one-way function (the cipher function) C2_G defined by the C2 cipher. Then, an intermediate key k1 is generated from data Dkc_1 and the intermediate key Kau through operation using the one-way function C2_G. Similarly, an intermediate key k2 is generated from data Dkc_2 and the intermediate key k1. Furthermore, an intermediate key k3 is generated from data Dkc_3 and the intermediate key k2. An intermediate key k4 is generated from data Dkc_4 and the intermediate key k3. The data Dkc_1, Dkc_2, Dkc_3, and Dkc_4 are parts of the encryption object pack data 914 which are assigned to the CCI-related data portion 915 of the encrypted pack 921. Finally, a contents encryption key Kc is generated from data Dkc_5 and the intermediate key k4. The data Dkc_5 is a part of the encryption object pack data 914 which is assigned to the variable data portion 916 of the encrypted pack 921. The remaining 1920-byte part Du of the encryption object pack data 914 is encrypted in response to the contents encryption key Kc through operation using the function C2_ECBC defined by the C2 cipher. The encrypted 1920-byte data (the encryption-resultant data) De is assigned to the encrypted data portion 917 of the encrypted pack 921.

The reproducing apparatus 93 reads out the data of the media key block (MKB) 911, the data of the album ID (ID_{album}) 913, and the encrypted pack 921 from the DVD-Audio disc 92.

The reproducing apparatus 93 has data representative of a device key (Kd_0, Kd_1, . . . , Kd_15). The reproducing apparatus 93 restores the media key (Km) 912 from the read-out media key block (MKB) 911 and the device key (Kd_0, Kd_1, . . . , Kd_15) through an MKB process.

In the reproducing apparatus 93, the intermediate key Kau is generated from the restored media key 912 and the read-out album ID (ID_{album}) 913 through operation using the one-way function C2_G. Then, the intermediate key k1 is generated from the read-out data Dkc_1 and the intermediate key Kau through operation using the one-way function C2_G. Similarly, the intermediate key k2 is generated from the read-out data Dkc_2 and the intermediate key k1. Furthermore, the intermediate key k3 is generated from the read-out data Dkc_3 and the intermediate key k2. The intermediate key k4 is generated from the read-out data Dkc_4 and the intermediate key k3. The data Dkc_1, Dkc_2, Dkc_3, and Dkc_4 are in the CCI-related data portion 915 of the read-out encrypted pack 921. Finally, the contents encryption key Kc is generated from the read-out data Dkc_5 and the intermediate key k4. The data Dkc_5 is in the variable data portion 916 of the read-out encrypted pack 921. The 1920-byte encrypted data De in the encrypted data portion 917 of the read-out encrypted pack 921 is decrypted into the 1920-byte original data Du in response to the contents encryption key Kc through operation using the function C2_DCBC defined by the C2 cipher.

The above-mentioned CPPM-based encryption/decryption repetitively uses the one-way function C2_G defined by the C2 cipher. The data processing stages in the encryption which use the one-way function C2_G are the same in structure as those in the decryption. Accordingly, these data processing stages using the one-way function C2_G are common to the encryption and the decryption for copyright protection. The data processing stages using the one-way function C2_G correspond to the core portion of the decryption algorithm which is given a predetermined high level of confidentiality. As previously mentioned, the core portion of the decryption algorithm is implemented by the core decryptor 65 formed by a hardware device (for example, an electronic circuit). Thus, the data processing stages using the one-way function C2_G are implemented by the core decryptor 65.

Steps of inputting various data to the core decryptor 65, and a step of making a judgment about a branch condition correspond to the non-core portion of the decryption algorithm which is given a predetermined low level of confidentiality. As previously mentioned, the non-core portion of the decryption algorithm is implemented by the execution of the non-core decryption program 113 by the non-core decryptor 63. Thus, the steps of inputting the various data to the core decryptor 65, and the step of making the judgment about the branch condition are incorporated in the non-core decryption program 113, and are implemented by the non-core decryptor 63 through the execution of the non-core decryption program 113.

The disc making equipment 91 has a copyright-protection encrypting section including a data processing section repetitively using the one-way function C2_G. The reproducing apparatus 93 has a copyright-protection decrypting section including a data processing section repetitively using the one-way function C2_G. The data processing section in the disc making equipment 91 and the data processing section in the reproducing apparatus 93 are the same in structure. Accordingly, the data processing section repetitively using the one-way function C2_G is common to the encryption by the disc making equipment 91 and the decryption by the reproducing apparatus 93. The data processing section repetitively using the one-way function C2_G is designated as the core portion of the encryption algorithm or the core portion of the decryption algorithm.

In the event that the CPPM system is broken, the present encryption and decryption algorithms are replaced by new ones. The new encryption and decryption algorithms are similar to the present ones except that an intermediate key Kau is generated as the one-way function C2_G is used twice or thrice rather than once. It is unnecessary to modify the core decryptor 65 as the present encryption and decryption algorithms are replaced by the new ones. In this way, it is possible to update or change the encryption and decryption algorithms utilized by the disc making equipment 91 and the reproducing apparatus 93.

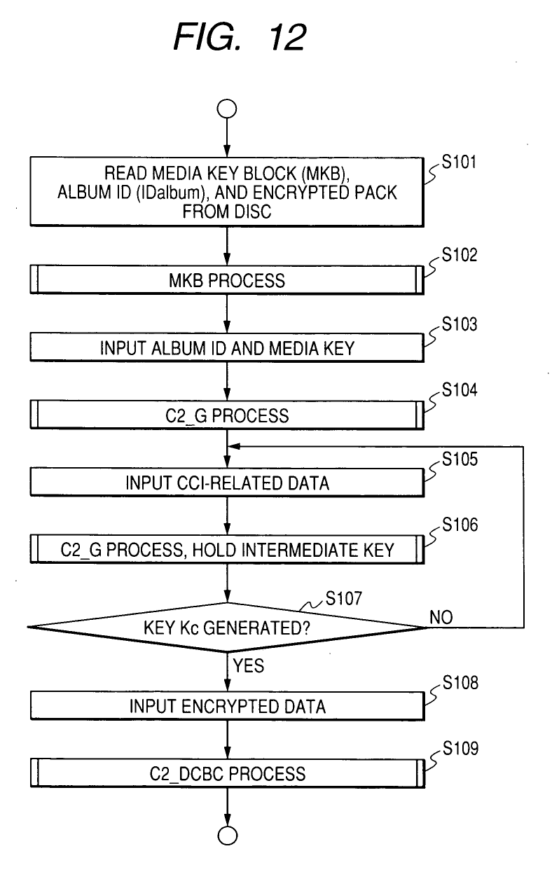

FIG. 12 is a flowchart of the decryption procedure performed by the reproducing apparatus 93 for copyright protection based on the CPPM system. With reference to FIG. 12, a first step S101 of the decryption procedure reads out the data of the media key block (MKB) 911, the data of the album ID (ID_{album}) 913, and the encrypted pack 921 from the DVD-Audio disc 92.

A step S102 following the step S101 restores the media key (Km) 912 from the read-out media key block (MKB) 911 and the device key (Kd_0, Kd_1, . . . , Kd_15) through the MKB process. The step S102 may hold the restored media key 912 in a memory within the core decryptor 65. The step S102 is assigned to the core decryptor 65.

A step S103 subsequent to the step S102 inputs the read-out album ID (ID_{album}) 913 to the core decryptor 65. The step S103 may input the read-out album ID (ID_{album}) 913 and the restored media key 912 to the core decryptor 65.

A step S104 following the step S103 generates the intermediate key Kau from the media key 912 and the album ID (ID_{album}) 913 through the operation using the one-way function C2_G. The step S104 holds the generated intermediate key Kau in the memory within the core decryptor 65. The step S104 is assigned to the core decryptor 65. After the step S104, the decryption procedure advances to a step S105.

The step S105 inputs one of the read-out data Dkc_1, Dkc_2, Dkc_3, Dkc_4, and Dkc_5 to the core decryptor 65. The data Dkc_1, Dkc_2, Dkc_3, and Dkc_4 is in the CCI-related data portion 915 of the read-out encrypted pack 921. The data Dkc_5 is in the variable data portion 916 of the read-out encrypted pack 921. At the first time, the step S105 inputs the read-out data Dkc_1 to the core decryptor 65. At the second time, the step S105 inputs the read-out data Dkc_2 to the core decryptor 65. At the third time, the step S105 inputs the read-out data Dkc_3 to the core decryptor 65. At the fourth time, the step S105 inputs the read-out data Dkc_4 to the core decryptor 65. At the fifth time, the step S105 inputs the read-out data Dkc_5 to the core decryptor 65.

A step S106 following the step S105 generates one of the intermediate keys k1, k2, k3, and k4 and the contents encryption key Kc from the read-out data currently inputted by the step S105 and the intermediate key generated by the step S104 or the intermediate key generated by the last execution of the step S106. The step S106 holds the generated key in the memory within the core decryptor 65. The step S106 is assigned to the core decryptor 65.

A step S107 subsequent to the step S106 judges whether or not the contents encryption key Kc has been generated by the step S106. When the contents encryption key Kc has been generated, the decryption procedure advances from the step S107 to a step S108. Otherwise, the decryption procedure returns from the step S107 to the step S105.

The step S108 inputs the 1920-byte encrypted data De in the encrypted data portion 917 of the read-out encrypted pack 921 to the core decryptor 65.

At a final step S109 following the step S108 decrypts the 1920-byte encrypted data De into the 1920-byte original data Du in response to the contents encryption key Kc through the operation using the function C2_DCBC. The step S109 is assigned to the core decryptor 65.

The step S102 for the MKB process and the steps S104, S106, and S109 which use the functions C2_G and C2_DCBC correspond to the core portion of the decryption algorithm which is given a predetermined high level of confidentiality. Accordingly, the steps S102, S104, S106, and S109 are designed to be executed and implemented by the core decryptor 65. On the other hand, the steps S101, S103, S105, S107, and S108 correspond to the non-core portion of the decryption algorithm which is given a predetermined low level of confidentiality. Accordingly, the steps S101, S103, S105, S107, and S108 are incorporated in the non-core decryption algorithm 113, and are hence executed and implemented by the non-core decryptor 63.

The copyright protecting encryption has data processing stages which repetitively use the one-way function C2_G. The copyright protecting decryption also has data processing stages which repetitively use the one-way function C2_G. The data processing stages in the encryption and the data processing stages in the decryption are the same in structure. Accordingly, these data processing stages using the one-way function C2_G are common to the encryption and the decryption for copyright protection. The data processing stages using the one-way function C2_G correspond to the core portion of the decryption algorithm which is given a predetermined high level of confidentiality. As previously mentioned, the core portion of the decryption algorithm is implemented by the core decryptor 65 formed by a hardware device (for example, an electronic circuit). Thus, the data processing stages using the one-way function C2_G are implemented by the core decryptor 65.

The copyright protecting decryption has data inputting and data judging stages corresponding to the non-core portion of the decryption algorithm which is given a predetermined low level of confidentiality. As previously mentioned, the non-core portion of the decryption algorithm is implemented by the execution of the non-core decryption program 113 by the non-core decryptor 63. Accordingly, the data inputting and data judging stages are incorporated in the non-core decryption program 113, and are hence executed by the non-core decryptor 63.

In the case of the DVD-Audio disc 92 in which copyright is protected by the CPPM system (or the CPRM system), although the core portion of the decryption algorithm remains the same, the decryption algorithm changes as the non-core portion thereof or the non-core decryption program 113 changes. Therefore, the decryption algorithm can easily be replaced with new one or updated into a new version by changing the non-core decryption program 113. A change in the non-core decryption program 113 enables the reproducing apparatus 93 to efficiently follow one selected from different encryption/decryption systems utilizing different encryption/decryption algorithms respectively. Furthermore, a change in the non-core decryption program 113 enables the reproducing apparatus 93 to follow a new encryption/decryption system without modification of the core decryptor 65.

As previously mentioned, the core decryptor 65 implements the core portion of the decryption algorithm. The core decryptor 65 is formed by a hardware device (for example, an electronic circuit) which is difficult to analyze. Thus, it is possible to provide anti-tamper performances higher than those occurring in an assumed case where the whole of the decryption algorithm is implemented by executing a corresponding decryption program.

### Fourth Embodiment

A fourth embodiment of this invention is similar to the first embodiment thereof except for design changes mentioned hereafter. The fourth embodiment of this invention utilizes encryption and decryption algorithms conforming with the DES (Data Encryption Standard). The DES may be replaced by the AES (Advanced Encryption Standard) or another encryption standard. Furthermore, the DES may be replaced by a combination of at least two of the DES, the AES, and other encryption standards.

In the fourth embodiment of this invention, the DES decryption algorithm has data processing stages repetitively using the cipher function f(Rn−1, Kn) where “n” denotes an integer in the range from 1 to 16. These data processing stages correspond to the core portion of the DES decryption algorithm which is given a predetermined high level of confidentiality. Accordingly, these data processing stages are assigned to the core decryptor 65.

The DES decryption algorithm has computation stages for repetitively performing permutations, substitutions referring to a lookup table “S-box”, modulo 2 addition (Exclusive-OR operation), and nonlinear transform. These computation stages correspond to the core portion of the DES decryption algorithm. Accordingly, these computation stages are assigned to the core decryptor 65.

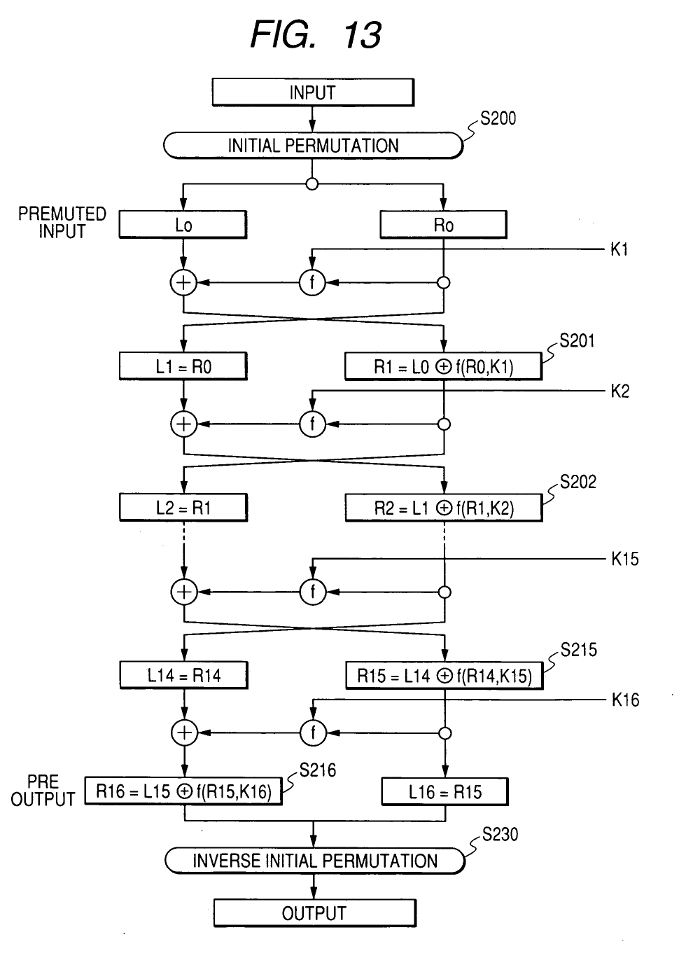

FIG. 13 is a data flow chart of a DES encrypting computation procedure executed by the recording apparatus 110. According to the DES, encryption and decryption are performed for every data block composed of 64 bits, and each of keys has a fixed length.

With reference to FIG. 13, at a first stage S200, an input data block is subjected to an initial permutation. The permutated input data block is then inputted to and processed by a sequence of stages including stages S201, S202, . . . , and S216.

In the stages S201, S202, . . . , and S216, computation using the cipher function f(Rn−1, Kn) is iterated 16 times while keys K1, K2, . . . , and K16 are sequentially used.

At a final stage S230, the output of the sequence of the stages including the stages S201, S202, . . . , and S216 is subjected to the inverse of the initial permutation.

The keys K1, K2, . . . , and K16 are generated and fed by a key scheduler (not shown). Each of the keys K1, K2, . . . , and K16 is composed of 48 bits. The keys K1, K2, . . . , and K16 are different from each other. The key scheduler iteratively chooses a block of 48 bits from 64-bit key data, and sets the chosen 48-bit block as one of the keys K1, K2, . . . , and K16.

The DES decrypting computation procedure executed by the reproducing apparatus 110 is inverse with respect to the DES encrypting computation procedure in FIG. 13. Thus, the DES decrypting computation procedure has stages corresponding to the permutation stages S200 and S230, and the cipher-function-based stages S201, S202, . . . , and S216 in FIG. 13. These stages in the DES decrypting computation procedure form the core portion of the DES decryption algorithm which is given a predetermined high level of confidentiality. Accordingly, these stages in the DES decrypting computation procedure are assigned to the core decryptor 65, and are hence executed and implemented by the core decryptor 65. Other stages in the DES decrypting computation procedure form the non-core portion of the DES decryption algorithm which is given a predetermined low level of confidentiality. Thus, the other stages in the DES decrypting computation procedure are incorporated in the non-core decryption program 113, and are hence executed by the non-core decryptor 63.

Although the core portion of the DES decryption algorithm remains the same, the DES decryption algorithm changes as the non-core portion thereof or the non-core decryption program 113 changes. Therefore, the DES decryption algorithm can easily be replaced with new one or updated into a new version by changing the non-core decryption program 113. A change in the non-core decryption program 113 enables the reproducing apparatus 110 to efficiently follow one selected from different encryption/decryption systems utilizing different encryption/decryption algorithms respectively. Furthermore, a change in the non-core decryption program 113 enables the reproducing apparatus 110 to follow a new encryption/decryption system without modification of the core decryptor 65.

As previously mentioned, the core decryptor 65 implements the core portion of the DES decryption algorithm. The core decryptor 65 is formed by a hardware device (for example, an electronic circuit) which is difficult to analyze. Thus, it is possible to provide anti-tamper performances higher than those occurring in an assumed case where the whole of the DES decryption algorithm is implemented by executing a corresponding decryption program.

What is claimed is:

1. A contents-data reproducing apparatus comprising:
a signal reader for reading out encrypted contents data and a non-core decryption software program from a recording medium, the non-core decryption software program corresponding to a non-core portion of a decryption algorithm;
a non-core decryptor for processing the read-out encrypted contents data into first processed contents data by executing the read-out non-core decryption software program; and
a core decryptor including a hardware device for processing the first processed contents data into second processed contents data by implementing a core portion of the decryption algorithm.

2. A contents-data reproducing apparatus as recited in claim 1, wherein the core decryptor comprises:
an external bus;
an internal bus physically separate from the external bus;
a command register for receiving a command from the non-core decryptor via the external bus;
a data register for receiving input data from the non-core decryptor via the external bus, and for sending output data to the non-core decryptor via the external bus;
a decryption hardware module for processing the input data while implementing the core portion of the decryption algorithm;
a sequencer for controlling the data register and the decryption hardware module in response to the command received by the command register so that the input data will be sent from the data register to the decryption hardware module via the internal bus and will be processed into the output data by the decryption hardware module, and that the output data will be sent from the decryption hardware module to the data register via the internal bus.

3. A contents-data reproducing apparatus as recited in claim 1, wherein the decryption algorithm is for contents protection, and the core portion of the decryption algorithm which is implemented by the core decryptor includes a process repetitively using a cipher function.

4. A contents-data reproducing apparatus as recited in claim 1, wherein the core portion of the decryption algorithm which is implemented by the core decryptor includes a process using a cipher function.

5. A contents-data reproducing method comprising the steps of:
reading out encrypted contents data and a non-core decryption software program from a recording medium, the non-core decryption software program corresponding to a non-core portion of a decryption algorithm;
processing the read-out encrypted contents data into first processed contents data by executing the read-out non-core decryption software program; and
enabling a hardware decryptor to process the first processed contents data into second processed contents data by implementing a core portion of the decryption algorithm.
